(19) United States
(12) Patent Application Publication
(10) Pub. No.: US 2017/0091840 A1
(43) Pub. Date: Mar. 30, 2017

(54) ON DEMAND DELIVERY

(71) Applicant: Get Me, LLC, Dallas, TX (US)

(72) Inventors: Michael Gaubert, Dallas, TX (US); D. R. Dunlop, Frisco, TX (US)

(21) Appl. No.: 15/207,269

(22) Filed: Jul. 11, 2016

Related U.S. Application Data
(60) Provisional application No. 62/193,871, filed on Jul. 17, 2015.

(51) Int. Cl. G06Q 30/02; H04L 29/08

(52) U.S. Cl. CPC G06Q 30/0282; H04L 67/18

(57) ABSTRACT

Systems, software, and methods are provided for providing on demand services via an application on a user device. The on demand services may include moving or delivery services of people, items, or products from a start location to a destination location, or relatively almost any product to a user or location at any time.

### RELATED APPLICATIONS

This application claims priority to, and benefit from, provisional patent application Ser. No. 62/193,871, entitled “On Demand Delivery”, filed Jul. 12, 2015, and provisional patent application Ser. No. 62/349,603, entitled “On Demand Delivery”, filed Jun. 13, 2016, both of which are incorporated by reference for all purposes.

### BACKGROUND

Current fleet management systems employed for taxi and limousine fleet typically utilize onboard metering devices, radios, and cell phones to dispatch drivers and monitor fares. Such systems typically are not communicative to customers that are waiting for pickup. Furthermore, conventional approaches may rely on the customer making payment directly to the driver, by credit card or cash.

### OVERVIEW

Systems, software, and methods are provided for providing on demand services including moving people. Further embodiments include an on-demand service facilitating buying and delivering nearly any product to a user.

### BRIEF DESCRIPTION OF THE DRAWINGS

FIGS. 1A-C show a flow diagram illustrating information presentation and operation of a person transport service, according to an example.

FIGS. 2A-D show a flow diagram illustrating information presentation and operation of a delivery service, according to an example.

FIG. 3 illustrates a flow diagram of a method for person transport, according to an example.

FIG. 4 illustrates a flow diagram of a method for product order, purchase, and delivery, according to an example.

FIG. 5 illustrates a computing environment for providing on demand person and product delivery, according to an example.

### DESCRIPTION

People desire to have products delivered to them. Some people may be unwilling or unable to go get the products themselves. Furthermore, users may set up rides from a start point to and end point for travel.

Systems, software, and methods are provided for providing on demand services including moving people from location to location, or relatively almost any product to a user at any time.

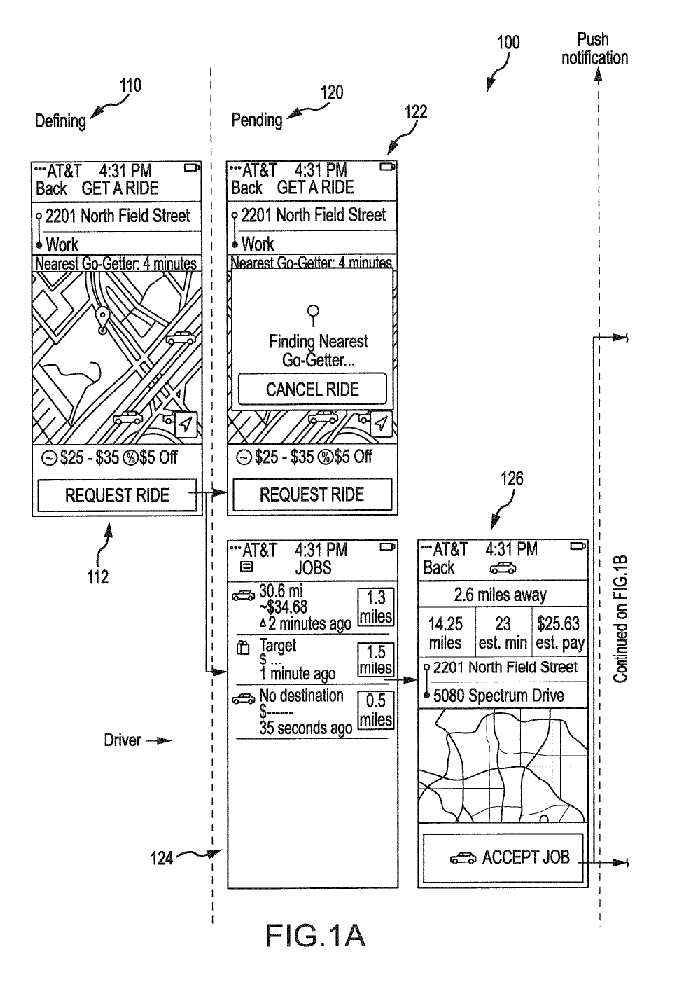

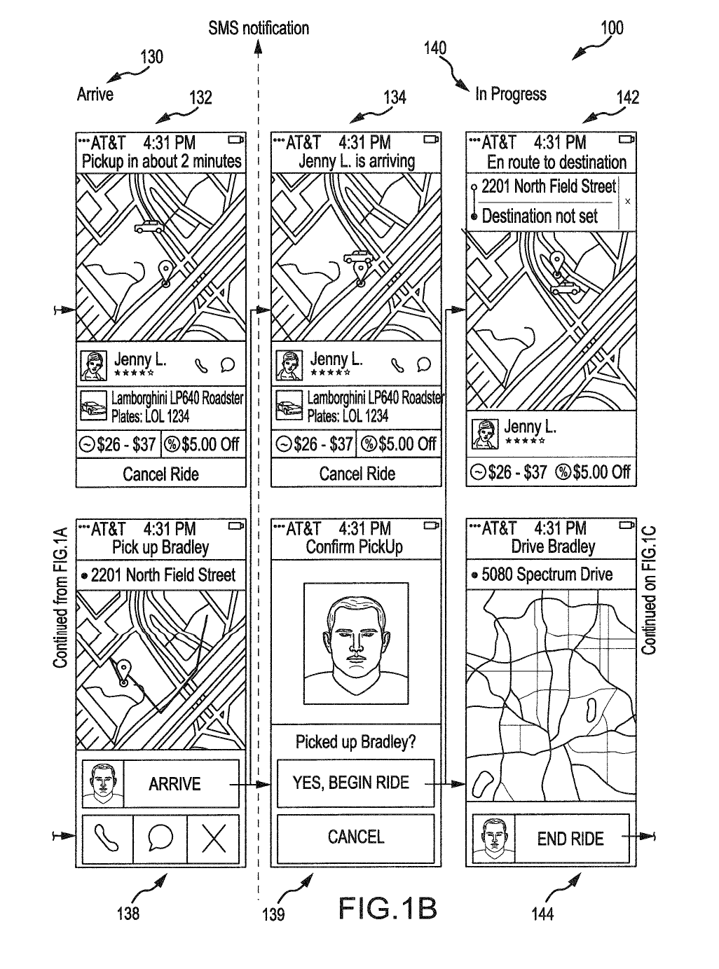

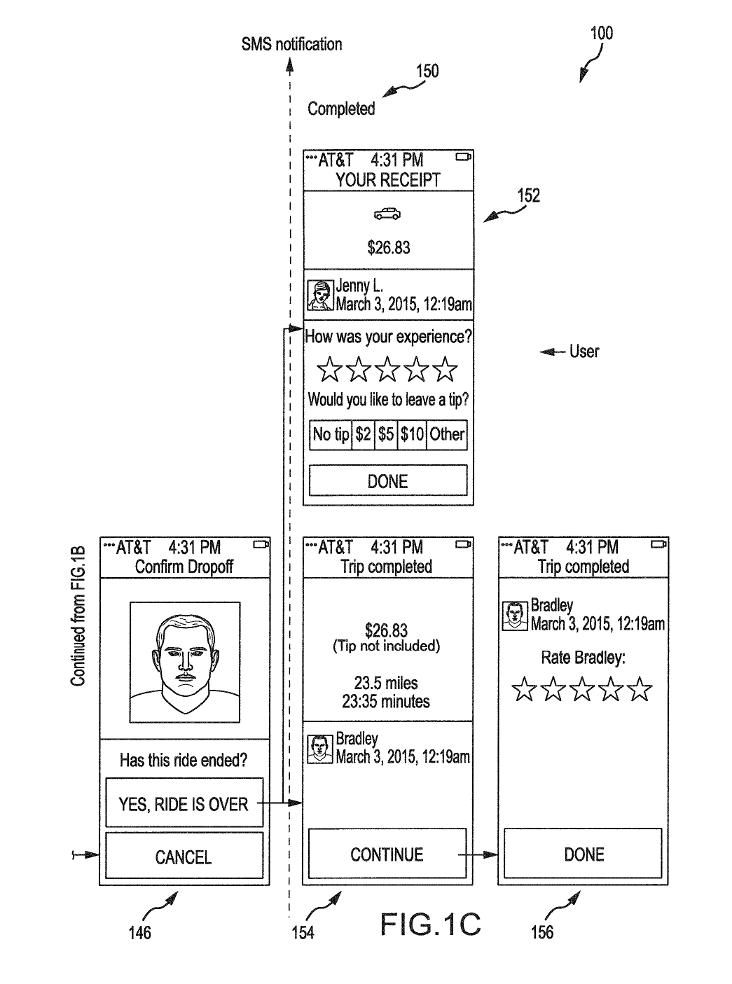

FIGS. 1A-C shows a diagram illustrating information and user interfaces flow of a transaction 100 for moving one or more users from a start location to an end location, according to an example. Transaction 100 includes a flow for a Driver and User as indicated. Transaction 100 includes a defining portion 110, a pending state 120, an arrive state 130, an in progress state 140, and a completed state 150.

A User, using a user device, may initiate and application (app). User device may include a smartphone, tablet, other web device, or other computing system. This may cause a server or other system to send a confirmation text including a transaction code to the user device for the user to enter to start a transaction.

According to an example, defining portion 110 includes an interface 112 presented to the User on a user device. Interface 112 may be capable of receiving inputs from a user, such as a start point and an end point on a map interface. The map interface and the distance between the start point and endpoint may be provided by Google™ Maps or other provider of mapping services.

Next the transaction 100 moves to a pending state 120. In the pending state or portion 120, the user device may be sent a waiting screen displaying that a “GoGetter” is being found 122. Included in this user interface may be a button for the user to indicate to cancel the transaction. The transaction may be cancelled before the Arrive state 130 occurs. The transaction may be cancelled with a fee thereafter.

Rather than the traditional alert or ding text message to every driver on the grid drivers may be alerted via push notifications, up to a maximum “pulse” radius of 10 miles from origination, on the driver device when there is a new customer request in the marketplace.

The radius intervals for the alerts may be 2.5 miles each blast up to 10 miles or 4 pulses. 2m 30s is desired timing for pulsing out jobs/alerts. The alerts may include the drivers who were already part of the smaller previous radius in the notification, such that the system will resend to previous radius as well as next radius. In an example, the closest drivers will get 4 “nudges” and 10 mile out would only get 1 “nudge”.

The initial “pulse” will radiate out to all drivers within the first 2.5 miles of the passenger pick up origination or business location. There will be a delay of 2m 30s before the next “pulse” of another 2.5 miles (now 5 mile radius) waiting again for 2m 30s . . . and so on until the request times out or is picked up.

The request will show up on the driver device as per the pulse distance—so a driver 5 miles out will not see the job until it hits their radius. It will be appreciated that other radii can be used based on location, driver availability, etc. Furthermore, the distance may be from the user device, starting location, or other location.

The driver device may receive and display all requested transactions with a starting point near or proximate the driver device from the server system. The driver may select a transaction to view. The start point, end point, and an estimated distance to the start point 124 may be sent to a driver device for display to a potential driver. Also included may be an estimated fare or charge to the user, an estimated amount the driver will make, an estimated distance, and estimated time to complete the transaction. The driver device may also present an indicator or button to accept the transaction or job.

Once the driver has accepted the transaction 100, a notification may be sent to a server or other system capable of controlling communications and other aspects of the transaction. Furthermore, an indication that a driver has accepted the transaction, a map with the driver device and the user device, and an estimated time of arrival may be sent to the user device.

The communication between the driver and user device may be facilitated by a dedicated channel identified by the transaction code, which was sent to the user device when the app was first opened. The dedicated channel may be created or defined by Pusher or other service. The dedicated channel may facilitate a dedicated communication channel for faster and more secure data transfer between the driver and the user device.

The transaction 100 may then begin the Arrive state or portion 130 when the driver device gets within a certain distance of the starting point. The user device may receive and present a map interface with the driver device location (indicated by a car or other vehicle), and the user device location when the driver device is relatively near the user device 132. Furthermore the user device may be sent, and may display, a picture of the driver, the type of vehicle and the license plate of the vehicle the driver is using.

The driver device may receive and present a map with the driver device location, a suggested route, and the start point. The user device may also include presentation of an indicator, such as a button, to indicate when the driver and driver device arrives at the starting point.

Once the driver presses the “Arrive” button, the driver device may send a text to the user device in addition to indicating on the app 134 that the driver is at the starting point. This may be an additional alert to the user device to insure the user does not miss the indication on the app, such as if the user is in a loud or busy place. This may make it less likely that a user will miss the alert and be charged for a transaction where the user did not get from the start point to the end point. This may reduce charges and waste of time for the driver and the user.

The driver device may then receive and display a picture of the user, as well as indicators to use to indicate “begin the ride” or cancel if the user does not show up at the start point. Information may also be sent to the server system, such as the time, location, etc.

If the driver indicates the ride has started, the transaction 100 enters the “In Progress” state 140. The in progress 140 may include the user device receiving and presenting a map interface with the location of the user device, the end point, a suggested route to be taken from the start point or the current location of the user device and the end point 142, and an estimated time to reach the end point.

At various time intervals, the location of the user device is updated, and the map interface scales in size to show the location of the user device and the end point near the edges of the screen as shown in 134 142. This may show more detail, such as street names, landmarks, and points of interest.

The driver device may receive and display a map interface with the location of the driver device, the end point, a suggested route, and an indication of traffic along the suggested route and other possible routes 144. At various time intervals, the location of the driver device may be updated, and the map interface scales in size to show the location of the driver device and the end point near the edges of the screen. This may show more detail, such as street names, landmarks, and points of interest.

The driver device interface may also include an indicator or button for the driver to press to indicate the ride is over or “END RIDE” 144. This information, along with trip information may then be sent to the server system via SMS notification or other communication. The trip information may include the begin time, end time, route traveled, fare, user, driver, and merchandise, and other information.

Once the trip is indicated as complete, the transaction may enter the “completed” portion 150. The user may be presented with information, on the user or other device, regarding the amount the user will be charged for the trip, as well as, rating information for rating the driver, a portion for adding a tip for the driver, and a button or indicator for indicating the transaction is done 152. Pressing the “DONE” button may close the application on the user device.

Payment information may be previously entered by the user. The user may have a previously set up account.

Once the trip is indicated as complete, the driver may be presented with the amount the user is charged, the trip distance, trip time, tip amount, as well as other information 154. The driver may then be presented, on the driver or other device, a means for rating the user, and a button or indicator that the transaction is “DONE” 156. Once the transaction is complete, the driver may be presented with an available jobs screen 124 on the driver device.

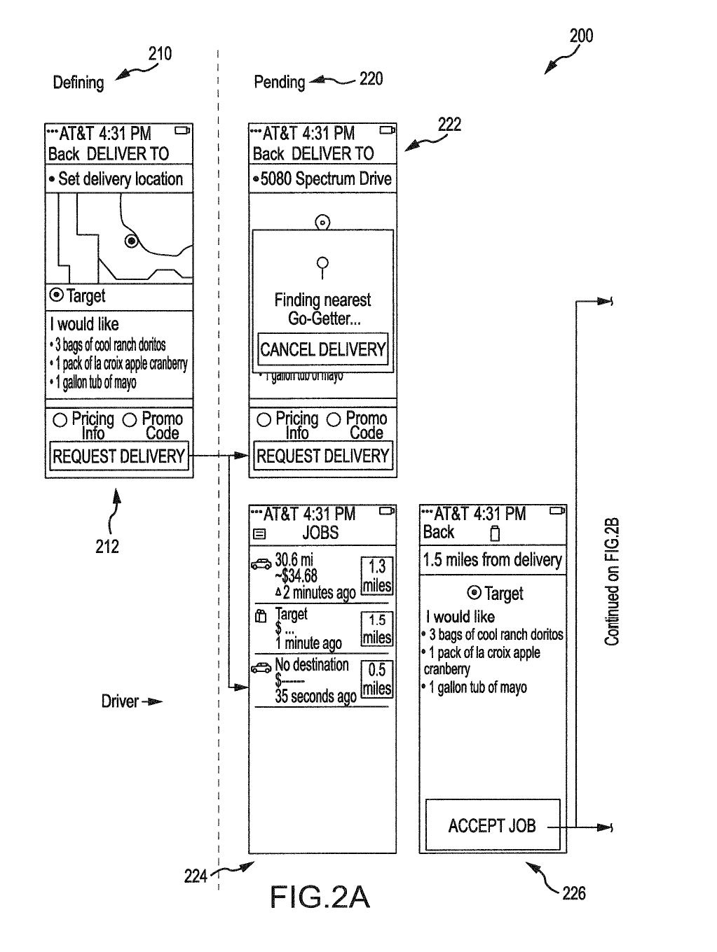

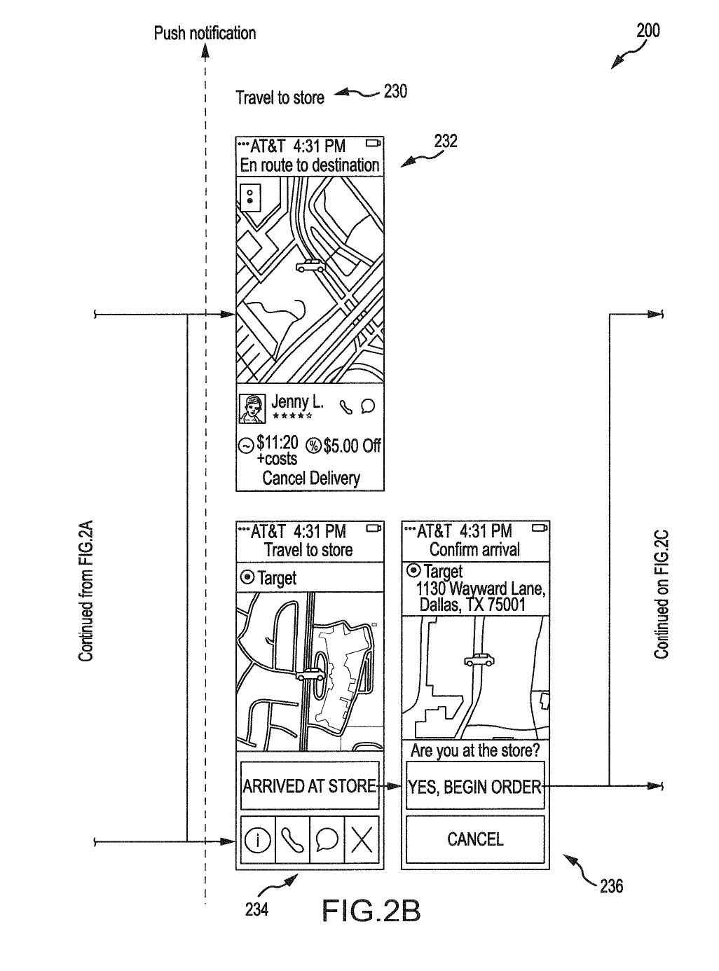

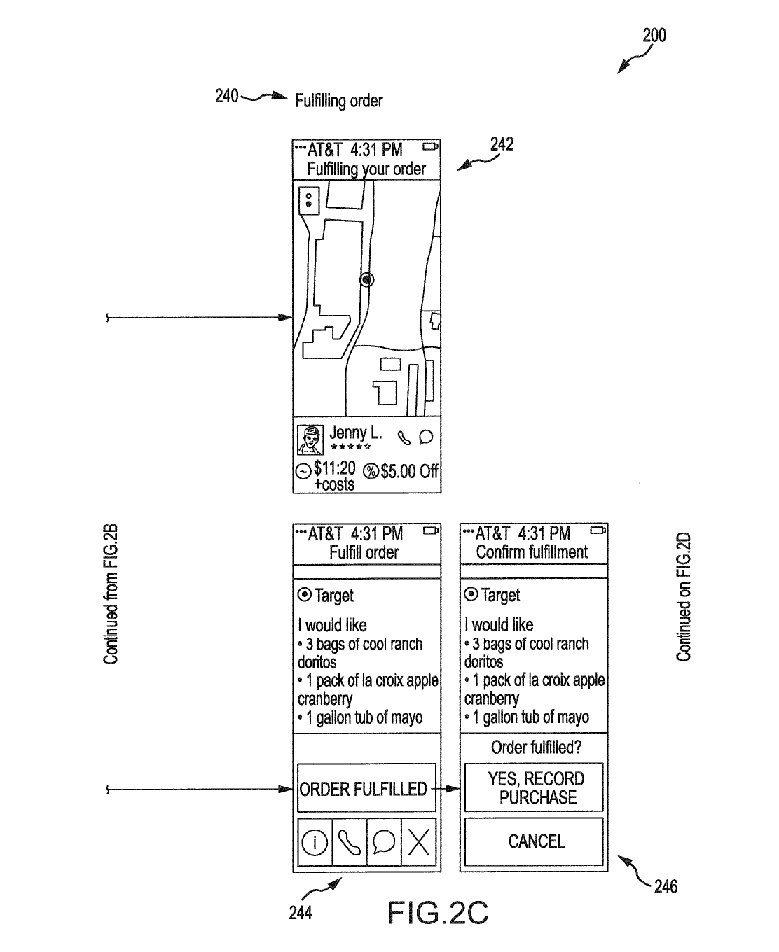

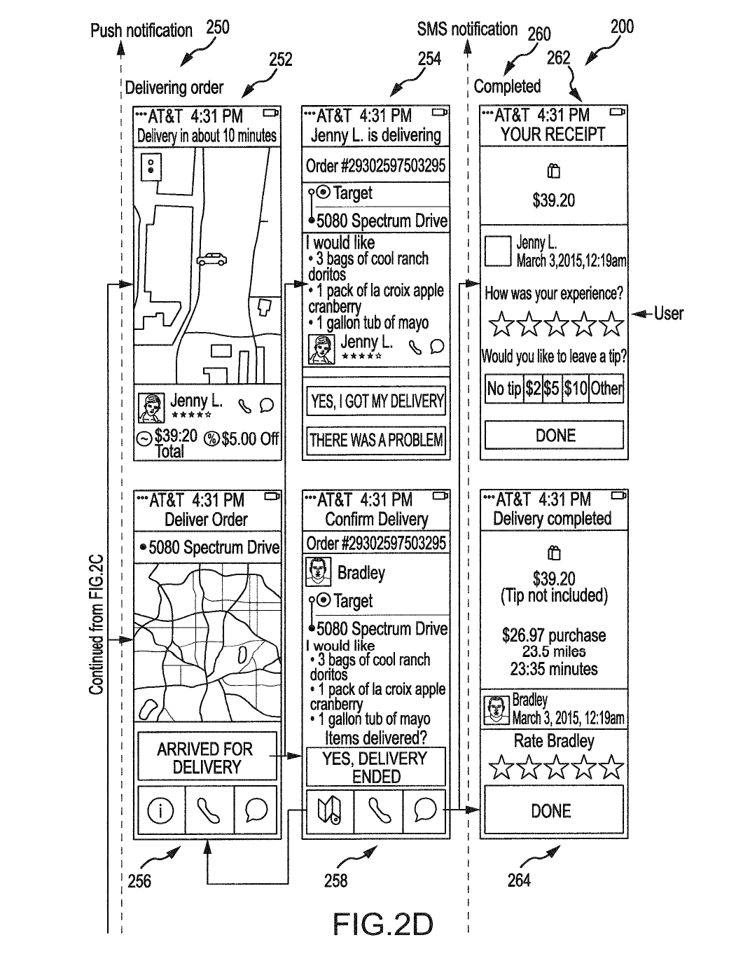

FIGS. 2A-D shows a diagram illustrating information and user interfaces flow of a transaction 200 for purchasing and moving merchandise from a start location to an end location, according to an example. Transaction 200 includes a flow for a DRIVER and USER as indicated. Transaction 200 includes a defining portion 210, a pending state 220, travel to store state 230, a fulfilling order state 240, a delivering order portion 250, and a completed state 260.

In the defining stage 210 the USER may be presented with information on the user interface of a user device which allows the user to identify a delivery end point, enter a store name, and enter the merchandise the user would like purchased and delivered 212.

After this information is entered, the transaction may enter the pending state 220, and the user may be presented with a “wait” screen 222 with a message that the nearest “Go Getters” or delivery persons are being located.

The DRIVER may be presented with information relating to available jobs 224. The information may include the end location, the identified store, an estimated amount for the trip and/or the merchandise, the distance to the identified store, the distance between the store and the end location, and other information. The driver may also be presented with a list of merchandise the user would like purchased 226. The driver may also be presented with a button or indicator to accept the job.

Once the driver has accepted the job or transaction, a notification may be sent to the server of the beginning and acceptance of the transaction, along with information about the store location, the destination or end location, the driver distance to the store, the estimated distance from the store to the send location, and estimated fare, the items to be purchased, and other information. The transaction may then progress to a “Travel to Store” portion 230 of the transaction. The transaction may not be cancelled after this point.

The driver and user may then be able to anonymously text or call each other for a period of time. This communication may be at least in part via a dedicated communication channel between the user device and the driver device is created to facilitate communication between the user device and the driver device. The driver and user may communicate about the merchandise to be purchased, such as if an item is not available at the identified store, would another item be acceptable or should the driver go to another store, or to communicate about any other matters.

Once the driver had accepted the transaction or job, the user may be presented information about the location of the driver on a map interface 232. The map interface may also provide the indication of the location of the store.

The driver may be presented with a suggest route from the driver's present location to the nearest identified store 234. The driver position may be indicated by the GPS within the driver device. The driver device may also present a button or indicator for the driver to indicate they have arrived at the identified store.

The driver device may them present a confirmation screen for the driver to confirm they are at the store 236. Once the drive has confirmed arrival at the identified store, the transaction may begin the “fulfilling order” portion 240 of the transaction. The user device may be sent the information to present on a user interface of the location of the driver device or vehicle and the identified store 242, showing that the driver is at the identified store.

The driver device may present the list of merchandise 244, and an indicator for the driver to indicate the order has been fulfilled and/or all the items have been purchased. Once the indication of the order has been filled has been received, the driver may be presented with a confirmation screen 246 to confirm all items have been purchased.

After receiving the confirmation, information may be sent to the server with status of the transaction, the items purchased, and other information. Also, the transaction may enter the “delivering order” portion 250 of the transaction.

The user may be presented, at the user device, with a map interface showing the location of the driver 252, which may include an estimated time of arrival at the end location or destination.

The driver may be presented, by the driver device, with a suggested route to the end location 256, and an indicator for indicating the driver has arrived at the end location. Once the driver has indicated that they have arrived at the end location, the user is presented with a screen showing a picture of the driver, the identified store, the end location, the merchandise, and other information 254.

The user may also be presented with an indicator indicating that the user has received the merchandise, or an indication that there was a problem. If there is an indication of a problem, the user may be presented with a screen to indicate what the problem was, or a call may be initiated to a customer service representative, or other action may be taken.

The driver may be presented with a screen with information including a picture of the user, the identified store, the end location, the merchandise, and/or other information 258. The driver may also be presented with an indicator for indicating the delivery or transaction has ended.

Once there is an indication from the driver that the delivery has ended information may be sent to the server including all of the details of the transaction, trip, purchases, etc. The transaction may then begin the “completed” portion 260.

The user may then be presented with information about the amount the transaction cost, an indication of the rating of the driver, an amount for tip, and a delivery complete button, and/or other information. The user may have previously set up an account including payment information.

The driver may be presented with information including the amount charged to the user. The amount charged to the user may include the amount paid for the merchandise, the delivery charge, the time the transaction took, the distance driven for the transaction, a picture of the user, a rating indication for the user, an indicator for indicating the transaction is “done”, and/or other information. The driver may then be presented with a list of available jobs or transactions 224.

The information about each trip may have various uses, include but not limited to, better scheduling and deployment of drivers, better serving users, anticipating user requests, etc. The anonymized information may be sold to various advertisers, or other companies for use. Furthermore, this service may be used with consumer websites for same day delivery of items ordered via a website. This service may also be used in conjunction with concierge services at hotels, etc.

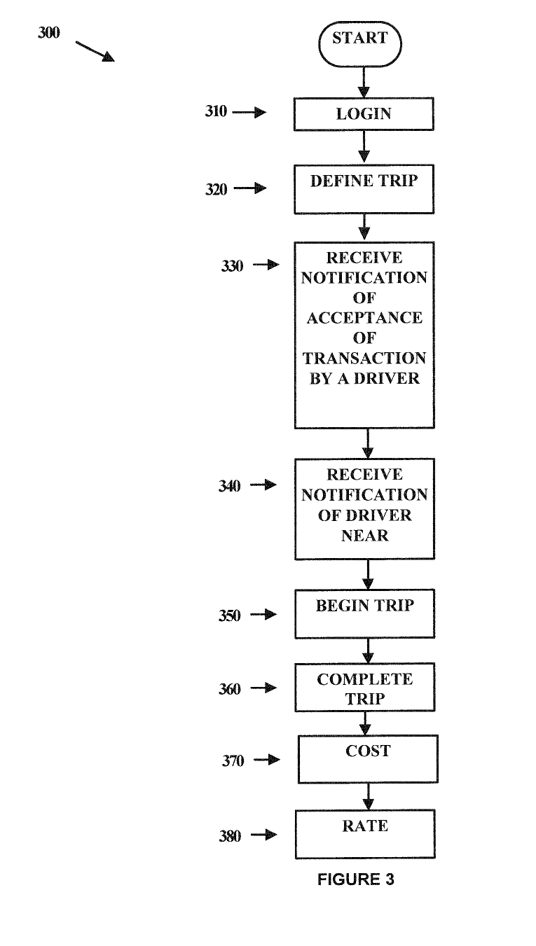

FIG. 3 describes the flow 300 in which a transaction may occur for the moving of a user from a start location to an end location. A user may send login information to a server (at 310) using a user device. The server may send a confirmation text to the user device including a confirmation code. The user may enter the confirmation code using the user device and be presented with information to define the trip on the user device.

The user may then enter information to define the trip or transaction (at 320). The entered information may include a start point and an end point, type of vehicle wanted, and other information. The user may then be presented or otherwise receive a notification, on the user device, of the acceptance of the transaction or ride by a driver (at 330).

The user may then be notified that the driver is near the start location (at 340). The user may be notified through the application on the user device, and may also be notified via a text message and/or cell phone call to insure the user is at, or going to the start point of the transaction.

Once the driver has picked up the user, the driver may indicate that the ride has begun. The user may then receive an indication that the ride has begun, or is in progress (at 350). The user device may receive and present status of the trip while the trip is in progress on a map interface showing the end location and the location of the driver and/or user device.

The user may receive an indication that the trip is complete (at 360), which may be initiated once the driver has indicated that the trip is complete and/or the driver device location is at the end point. Once the trip is completed, the user may be presented with the amount the trip cost (at 370), which may include a means of applying or otherwise paying or giving the driver a tip. The user may also be presented with a means of rating the driver (at 380).

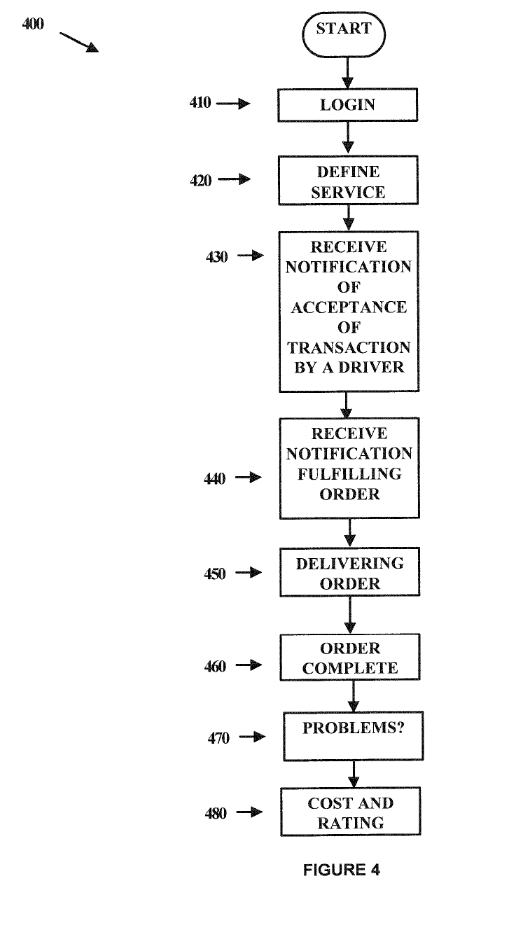

FIG. 4 describes the flow 400 in which a transaction may occur for the purchasing and delivering merchandise from a start location to an end location. A user may send login information to a server (at 410) using a user device. The server may send a confirmation text to the user device including a confirmation code. The user may enter the confirmation code using the user device and be presented with information to define the trip on the user device.

The user may then enter information to define the service or transaction (at 420). The entered information may include a start point and an end point, type of vehicle wanted, merchandise to purchase, identifying a desired store to purchase the merchandise from, and other information.

The user may receive notice that a driver has accepted the job and started the transaction (at 430). The user may then be presented with a map interface showing the location of the driver service and the location of the store. The interface may be updated to show fit to the screen until the driver device is stopped adjacent the identified store location.

The user may then be presented with an indication the order is being fulfilled (at 440). The user may then be presented with an indication that the order is being delivered (at 450). The user may be presented with a map interface showing the location of the driver device and the end location. The interface may update to show the driver device location and the end point enlarged to fit the screen. The map interface may be updates from time to time, and enlarging to fit the screen of the particular user device.

After the driver has indicated that the merchandise has been delivered, or the transaction or order is complete, the user may be presented with an indication that the order is complete (at 460). The user may be presented with a way of indicating the merchandise has been received and/or the transaction is completed. At various times during the transaction the user may be presented with a way of indicating there is a problem with the transaction (470). The user may then be presented with an indication of the cost of the transaction, and a way of rating the transaction and/or driver. (at 480).

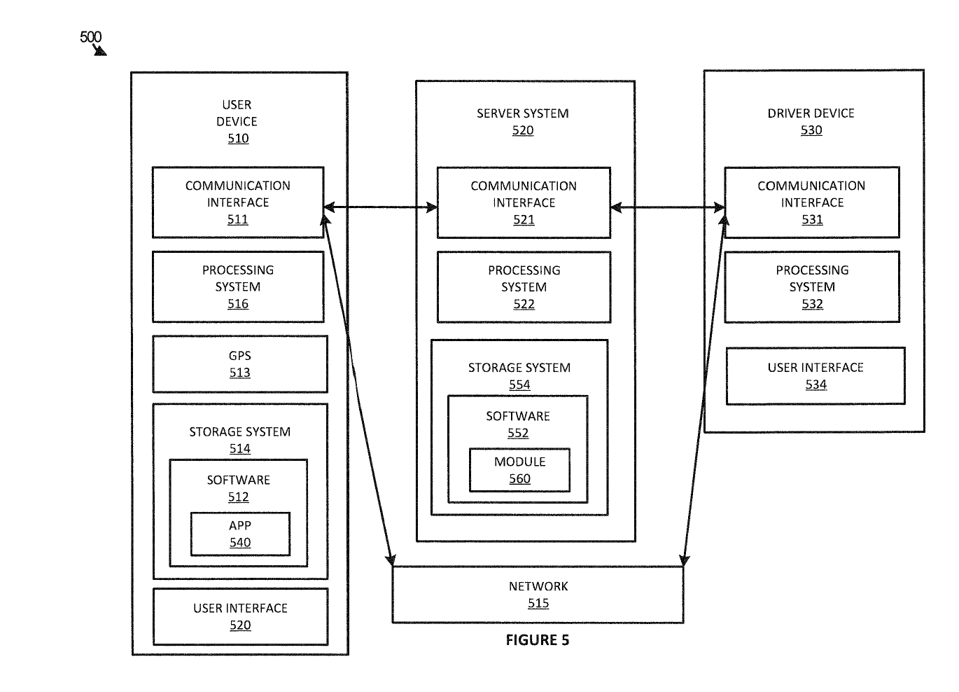

FIG. 5 illustrates an example computing environment 500 for facilitating the moving of a person from a start point to and end point, and/or the purchase and delivery of merchandise. Example computing environment 500 includes user device system 510, server system 520, and driver service 530. User device 510 and driver device 530, in the present example, may include a web device, and/or other computing system, which may be used for user facing information presentation and receiving of user or driver inputs, among other functionality. Server system 550 may be configured to provide the “back-end” processing, data storage, etc.

User device 510 and driver device 530 can include any smart phone, tablet computer, laptop computer, or other computing or mobile device capable of reading, receiving, displaying, and/or presenting data about trip and merchandise transactions. Devices 510 530 are also capable of receiving user inputs and communicating with each other as well as with server 520 and other systems. Server system 550 can include any server computer, desktop computer, laptop computer, or other device capable of storing and managing the data received from user device 510 and driver device 530, as well as hardware and software modules for providing processing and other functionality, as described herein.

User device 510 is connected to server system 520 via a communication link, which may the Internet and/or include various communication media, such as air, space, metal, optical fiber, or some other signal propagation path, including combinations thereof. Link could use various communication protocols, such as Internet Protocol (IP), Ethernet, Wireless Fidelity (Wi-Fi), Time Division Multiplexing (TDM), Asynchronous Transfer Mode (ATM), Code Division Multiple Access (CDMA), Evolution-Data Optimized (EV-DO), single-carrier radio transmission technology, Frame relay, optical, synchronous optical networking (SONET), or some other communication format, including combinations, improvements, or variations thereof. Link could be a direct link or may include intermediate networks, systems, or devices, and can include wired and/or wireless systems. In turn, server system 520 is connected to driver device 530 via a similar link, or any other type of communication link including combinations thereof.

In FIG. 5, user device 510 comprises communication interface 511, processing system 512, GPS 513, and user interface 514. Processing system 512 is configured to monitor data from GPS 513, user interface 514, driver device 530, server 520, and other sensors, either internal or external, for inputs and other information.

Examples of server system 530 include server computers, desktop computers, tablet computers, and telephones. Each of user device 510, server system 520, and driver device 530 can be a computing system which includes processing system, storage system, and software according to an example. Each processing system retrieves and executes software from a storage system (not shown). In some examples, processing system comprises specialized circuitry, and software or storage system could be included in the specialized circuitry to operate processing system as described herein.

Storage system could include a computer-readable medium such as a disk, tape, integrated circuit, server, or some other memory device, and also may be distributed among multiple memory devices.

Software may include an operating system, databases, utilities, drivers, networking software, and other software typically loaded onto a computer system. Software could contain an application program, firmware, or some other form of computer-readable processing instructions. When executed by processing system, software directs processing system to operate as described herein, such as to operate the methods and functionality described herein.

The server system 530 may include multiple underlying services and technologies which comprise services to an end user. Server system 530 refers to anything which is part of a service that is hosted remotely and accessible from anywhere via the Internet via a browser, smartphone app, or other communication link or system. Server system 520 acts as a central resource for communicating, at times, with the user 510 and driver devices 530.

Server system 520 can provide centralized messaging, computing, data storage, analytics, user management, device management, account management, location management, control messaging, asynchronous state messaging and displayed information, among other functionality. Server system 520 can act as a resource that sends and receives data from multiple devices and consolidates all data to provide a singular list of driver devices and jobs based on location, type of vehicle, or other grouping. Server system 520 may include software, firmware and hardware, of varying type, at various locations, and provide services to a user and driver seamlessly.

In FIG. 5, user device 510 includes processing system 516, storage system 514, software 512, communication interface 518, and user interface 520. Processing system 516 loads and executes software 512 from storage system 514, including smartphone application 540. When executed by computing system 510, app 540 directs processing system 516 to receive display information, receive and transmit user inputs, receive location information, communicate with other devices and/or servers, etc. Such data could include any of the information described above, including but not limited to the functionality described for FIGS. 1-4.

Although user device 510 is shown as including one software module 540 in the present example, it should be understood that one or more modules could provide the same or similar operation. Similarly, the computing systems and software may be distributed among many other computing systems and software locations and modules.

Additionally, user device 510 includes communication interface 511 that can be further configured to transmit the user inputs and data to server 520 and driver device 530 using communication network 515. Communication network 515 could include the Internet, cellular network, satellite network, RF communication, blue-tooth type communication, near field, or any other form of communication network capable of facilitating communication between devices 510, 530 and server 520.

Referring still to FIG. 5, processing system 516 can comprise a microprocessor and other circuitry that retrieves and executes software 512 from storage system 514. Processing system 516 can be implemented within a single processing device but can also be distributed across multiple processing devices or sub-systems that cooperate in executing program instructions. Examples of processing system 516 include general purpose central processing units, application specific processors, and logic devices, as well as any other type of processing device, combinations of processing devices, or variations thereof.

Storage system 514 can comprise any storage media readable by processing system 516, and capable of storing software 540. Storage system 514 can include volatile and nonvolatile, removable and non-removable media implemented in any method or technology for storage of information, such as computer readable instructions, data structures, program modules, or other data. Storage system 514 can be implemented as a single storage device but may also be implemented across multiple storage devices or sub-systems. Storage system 514 can comprise additional elements, such as a controller, capable of communicating with processing system 516.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

User interface 520 can include a mouse, a keyboard, a camera, a touch screen, image capture, a Barcode scanner, a QR scanner, a voice input device, a touch input device for receiving a gesture from a user, a motion input device for detecting non-touch gestures and other motions by a user, and other comparable input devices and associated processing elements capable of receiving user input from a user. These input devices can be used for defining and receiving data about the systems, devices, locations, and/or equipment, etc.

Output devices such as a graphical display, speakers, printer, haptic devices, and other types of output devices may also be included in user interface 520. The aforementioned user input and output devices are well known in the art and need not be discussed at length here. User interface 520 may also include a display capable of presenting interfaces and information as described within this disclosure.

User device 510 may also include a global positioning system hardware and software to provide global location information. User device 510 may also include other functionality of a smartphone, tablet, personal computer, etc. User device 510 may also receive location information of drivers and other devices, locations, etc. More than one device 510, 530 may communicate directly with each other as described within this disclosure.

In an example, server 520 includes processing system 522, storage system 554, software 552, and communication interface 521. Processing system 556 loads and executes software 552 from storage system 554, including software module 560. When executed by computing system 550, software module 560 directs processing system 556 to store and manage the data from devices 510 530 and other similar computing systems and/or devices. The data can include information about devices, locations, etc., as well as one or more software modules to control, configure, manipulate devices, etc.

Although server system 520 is shown as including one software module in the present example, it should be understood that one or more modules could provide the same operation. Additionally, server system 520 includes communication interface 521 that can be configured to receive the data from devices 510 530 at least in part via a communication network show by arrows in FIG. 5.

Referring still to FIG. 5, processing system 522 can comprise a microprocessor and other circuitry that retrieves and executes software 552 from storage system 554. Processing system 522 can be implemented within a single processing device but can also be distributed across multiple processing devices or sub-systems that cooperate in executing program instructions. Examples of processing system 522 include general purpose central processing units, application specific processors, and logic devices, as well as any other type of processing device, combinations of processing devices, or variations thereof.

Storage system 554 can comprise any storage media readable by processing system 522, and capable of storing software 552 and data from devices 510 530 and other sources. Data from devices 510 530 and other sources may be stored in a database or any other form of digital file. Storage system 554 can include volatile and nonvolatile, removable and non-removable media implemented in any method or technology for storage of information, such as computer readable instructions, data structures, program modules, or other data. Storage system 554 can be implemented as a single storage device but may also be implemented across multiple storage devices or sub-systems. Storage system 554 can comprise additional elements, such as a controller, capable of communicating with processing system 522.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

In some examples, server 520 could include a user interface The user interface can include a mouse, a keyboard, a voice input device, a touch input device for receiving a gesture from a user, a motion input device for detecting non-touch gestures and other motions by a user, and other comparable input devices and associated processing elements capable of receiving user input from a user.

Output devices such as a graphical display, speakers, printer, haptic devices, and other types of output devices may also be included in the user interface. The aforementioned user input and output devices are well known in the art and need not be discussed at length here.

It should be understood that although server system 520 is shown as one system, the system can comprise one or more systems to store and manage received data. Server system 520 may include cloud-based and web-hosted type systems.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for enabling transportation of individuals and products, comprising;
receiving user login information from a user device, at a server;
sending confirmation information to the user device;
receiving a request for service from the user device, wherein the service comprises a start location, end location, and type of vehicle;
sending an estimate for the services requested to be presented at the user device;
sending the request for service to a driver device;
receiving an acceptance for the services at the server from the user device;
receiving an indication the driver is at or near the starting location;
sending an indication to the user device comprising the location of the driver device;
receiving an indication from the driver device a trip from the starting location to the ending location has commenced;
receiving an indication at the server from the driver device that the trip has ended;
sending a final cost at the user device;
sending a customer satisfaction and tip option to the user device; and
receiving an indication of level of customer satisfaction from the user device.

2. The method of claim 1, wherein the request for service cannot be cancelled after the receipt of the indication of the driver at or near the starting location.

3. The method of claim 1, wherein user login comprises receiving a text-receiving device identifier, sending a trip identifier to the identified text-receiving device, and receiving at the server, the trip identifier from the text-receiving device.

4. The method of claim 1, wherein the test-receiving device comprises a cellular telephone or other device capable of sending and receiving texts.

5. The method of claim 4, wherein the text-receiving device comprises the user device.

6. The method of claim 1, further comprising sending an indication to the user device when the driver device in near the starting location.

7. The method of claim 1, further comprising activating an application on the user device to facilitate the request for services.

8. The method of claim 1, further comprising periodically sending an indication to the user device comprising the location of the driver device.

9. The method of claim 1, further comprising sending an indication to the user device showing a route between the starting location and the ending location.

10. The method of claim 9, further comprising sending an indication to the user device of the location of the user device and the remaining route between the user device and the ending location.

11. The method of claim 1, wherein the request for services further comprises a desired product.

12. The method of claim 1, wherein a dedicated communication channel between the user device and the driver device is created to facilitate more rapid and safe communication between the user device and the driver device.

13. The method of claim 1, wherein the sending the request for service to a driver device comprises sending the request for service to driver devices most proximate the location of the user device or the starting location.

14. The method of claim 13, wherein most proximate is generally within 2.5 mile radius increments.

15. A non-volatile commuter readable medium, having stored thereon instructions for facilitating a request for transportation of people or products, which if executed by a processor, cause the processor to:
receive user login from a user device, at a server, wherein user login comprises receiving a user device identifier, sending a trip identifier to the identified user device, and receiving at the server, the trip identifier from the user device;
send confirmation information to the user device;
receive a request for service from the user device, wherein the services comprise a starting location, ending location, and type of vehicle;
send an estimate for the services requested to be presented at the user device;
send the request for service to a driver device;
receive an acceptance for the services at the server from the user device;
receive an indication the driver is at or near the starting location;
send an indication to the user device comprising the location of the driver device;
receive an indication from the driver device a trip from the starting location to the ending location has commenced;
receive an indication at the server from the driver device that the trip has ended;
send a final cost at the user device;
send a customer satisfaction and tip option to the user device; and
receive an indication of level of customer satisfaction from the user device,
wherein the request for service cannot be cancelled after the receipt of the indication of the driver at or near the starting location.

16. The computer readable medium of claim 15, having further instructions, which cause the processor to send an indication to the user device when the driver device in near the starting location.

17. The computer readable medium of claim 15, having further instructions, which if executed by the processor cause the processor to send an indication to the user device showing a route between the starting location and the ending location.

18. The computer readable medium of claim 17, having further instructions, which if executed by the processor cause the processor to send an indication to the user device of the location of the user device and the remaining route between the user device and the ending location.

19. A system for facilitating a request for transportation of people or products, comprising:
a computing system capable of receiving user login from a user device, sending confirmation information to the user device; receiving a request for service from the user device, sending an estimate for the services requested to be presented at the user device; sending the request for service to a driver device; receiving an acceptance for the services from the user device; receiving an indication the driver is at or near the starting location; sending an indication to the user device comprising the location of the driver device; receiving an indication from the driver device a trip from the starting location to the ending location has commenced; receiving an indication at the server from the driver device that the trip has ended; sending a final cost at the user device; sending a customer satisfaction and tip option to the user device; and receiving an indication of level of customer satisfaction from the user device,
wherein the request for service cannot be cancelled after the receipt of the indication of the driver at or near the starting location,
wherein user login comprises receiving a user device identifier, sending a trip identifier to the identified user device, and receiving the trip identifier from the user device,
wherein the services comprise a starting location, and ending location.

20. The system of claim 19, wherein request for services comprises desired product information relating to a product to be purchased, and wherein the desired product information is sent to the driver device.

21. The system of claim 19, wherein a dedicated communication channel between the user device and the driver device is created to facilitate more rapid and safe communication between the user device and the driver device.
